(19) United States
(12) Patent Application Publication
(10) Pub. No.: US 2006/0121147 A1
(43) Pub. Date: Jun. 8, 2006

(54) Jig used in forming cover layer of small form factor optical disk and method of forming cover layer in small form factor optical disk using the same

(76) Inventors: Ho Jun Ryn, Seoul (KR); Yong Goo Yoo, Daejeon-city (KR); Woo Seok Cheong, Daejeon-city (KR); Dong Woo Suh, Daejeon-city (KR); Mun Cheol Paek, Daejeon-city (KR); Kwang Yong Kang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/271,051

(22) Filed: Nov. 10, 2005

(30) Foreign Application Priority Data
Dec. 8, 2004 (KR) 10-2004-0103065
Jun. 7, 2005 (KR) 10-2005-0048398

(51) Int. Cl. B28B 11/08; B29D 17/00; B29C 59/00; A01J 21/00; A01J 25/12; A21C 11/02; A21C 3/00; A23G 1/20; A23G 3/00; A23P 1/00; B28B 21/00

(52) U.S. Cl. 425/385; 264/1.33

(57) ABSTRACT

Provided are a jig used in a forming a cover layer of a small form factor optical disk and a method forming a cover layer in a small form factor optical disk using the jig. The jig includes: a body; a cylindrical wall formed inside the body and mounting an optical disk plate to a predetermined depth; and a pin positioned in a center of the cylindrical wall and combined with a central hole of the optical disk plate.

### CROSS-REFERENCE TO RELATED PATENT APPLICATION

This application claims the benefit of Korean Patent Application Nos. 10-2004-0103065, filed on Dec. 8, 2004 and 10-2005-0048398, filed on Jun. 7, 2005, in the Korean Intellectual Property Office, the disclosures of which are incorporated herein in their entirety by reference.

### BACKGROUND OF THE INVENTION

1. Field of the Invention

The present invention relates to a jig used in forming a cover layer of a small form factor optical disk and a method of forming a cover layer in a small form factor optical disc using the same.

2. Description of the Related Art

In general, information is recorded on, stored in, and/or reproduced an optical disk using a laser beam. CD, CD-R, CD-RW, or DVD-group high density optical disks each have a diameter of 120 mm and a storage between 700 Mbyte and 4.7 Gbyte. Such a high density optical disk was realized by a reduction in a spot of a laser beam used for recording and reproducing, a reduction in a track pitch, and a use of a short wavelength laser.

A method of recording information on a high density optical disk is performed according to the following process. A laser beam is emitted from a laser light source of an information storage device, for example, an optical storage device, passes through an optical system, and penetrates through a transparent substrate of an optical disk. Thereafter, the laser beam reacts with a recording layer of the optical disk, is reflected from a reflective layer, and finally detected by a photodetector.

A blue laser beam having a short wavelength of 405 nm and an objective lens having a high aperture are used to realize the high density optical disk. However, a coma aberration is increased by the thickness of the high density optical disk. Thus, a focal point is not precisely formed. As a result, the thickness of a cover layer formed on a transparent substrate was suggested to be within a range of 100 um to reduce a coma aberration in an information storage device.

In a case where a diameter of the optical disk is 120 mm, the cover layer of the optical disk is formed using a spin coating method. However, in a case where a size of the optical disk is gradually reduced so that a diameter is 28 mm, a stable sheer strength may not be formed. Thus, the cover layer may not be formed using the spin coating method.

Therefore, a method of adhering a polymer film on a surface of an optical disk plate using an adhering method has been suggested to form a cover layer of a high density small form factor optical disk. The method includes a process of adhering thin adhesive films having an adhesive strength on both sides of the optical disk plate and a process of adhering the polymer film on the adhesive films.

However, the two processes are complicated and must be performed in clean conditions that foreign materials are not intervened between the two processes. Thus, the method increases cost for fabricating an optical disk.

### SUMMARY OF THE INVENTION

The present invention provides a jig used in forming a cover layer of a small form factor optical disk so as not to use a process of adhering an adhesive film or a polymer film during forming of the cover layer.

The present invention also provides a method of forming a cover layer of a small form factor optical disk using the jig without using an adhering method.

According to an aspect of the present invention, there is provided a jig used in forming a cover layer of a small form factor optical disk, including: a body; a cylindrical wall formed inside the body and mounting an optical disk plate to a predetermined depth; and a pin positioned in a center of the cylindrical wall and combined with a central hole of the optical disk plate. A diameter of the cylindrical wall may be equal to a diameter of the optical disk plate. A plurality of walls may be formed inside the body. A plurality of walls may be arranged in a row in horizontal and vertical directions inside the body.

According to another aspect of the present invention, there is provided a method of forming a cover layer of a small form factor optical disk, including: mounting a small form factor optical disk plate in a jig comprising a body, a cylindrical wall formed to a predetermined depth inside the body, and a pin positioned in a center of the cylindrical wall; coating an optical hardening material layer on an optical disk plate mounted in the jig; planarizing the optical hardening material layer; hardening the optical hardening material layer to form a cover layer on the optical disk plate; and separating the optical disk plate on which the cover layer has been formed from the jig.

The optical hardening material layer may be coated using a screen printing method. The optical hardening material layer may be planarized by a planarizer. The cover layer may be formed to a thickness corresponding to a difference between a height of the pin of the jig and a thickness of the optical disk plate.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a jig used in a method of forming a cover layer of a small form factor optical disk according to an embodiment of the present invention;

FIG. 2 is a perspective view of a jig used in a method of forming a cover layer of a small form factor optical disk according to another embodiment of the present invention;

FIG. 3 is a cross-sectional view of a jig used in a method of forming a cover layer of a small form factor optical disk according to an embodiment of the present invention; and

FIGS. 4 through 8 are cross-sectional views illustrating a method of forming a cover layer of a small form factor optical disk using a jig according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity.

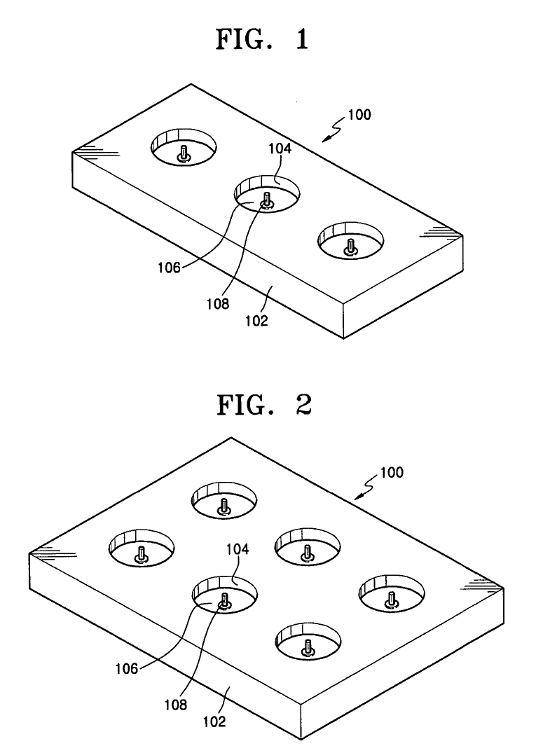

FIG. 1 is a perspective view of a jig used in a method of forming a cover layer of a small form factor optical disk according to an embodiment of the present invention

In detail, a jig 100 used in a method of forming a cover layer of a small form factor optical disk includes a body 102 and a plurality of walls 104 that are formed inside the body 102, have cylindrical shapes, exposed surfaces, predetermined depths, and predetermined diameters, and mount optical disk plates (not shown) therein. The body 102 is formed of a metal material.

Optical disk plates including reflective layers, dye data receiving layers, or metal layers on substrates are mounted in the walls 104 during forming of cover layers. Diameters of the walls 104 are equal to diameters of the optical disk plates, for example, 28 mm. Upper surfaces of the walls 104 are equal to an upper surface of the body 102. In other words, the upper surfaces of the walls 104 are formed of the upper surface of the body 102. Bottoms 106 of the walls 104 are formed to predetermined depths inside the body 102. The depths of the walls 104 are larger than thicknesses of the optical disk plates.

Pins 108 are positioned inside the walls 104. In other words, the pins 108 are positioned in centers of the walls 104. The pins 108 are combined with central holes (viaholes) of the optical disk plates. Heights of the pins 108 are equal to heights of the walls 104. Diameters of the pins 108 are equal to diameters of the central holes of the optical disk plates. Thus, the optical disk plates having the central holes are mounted in the walls 104 using the pins 108. As will be described later, cover layers may be simply and uniformly formed on the optical disk plates mounted in the walls 104.

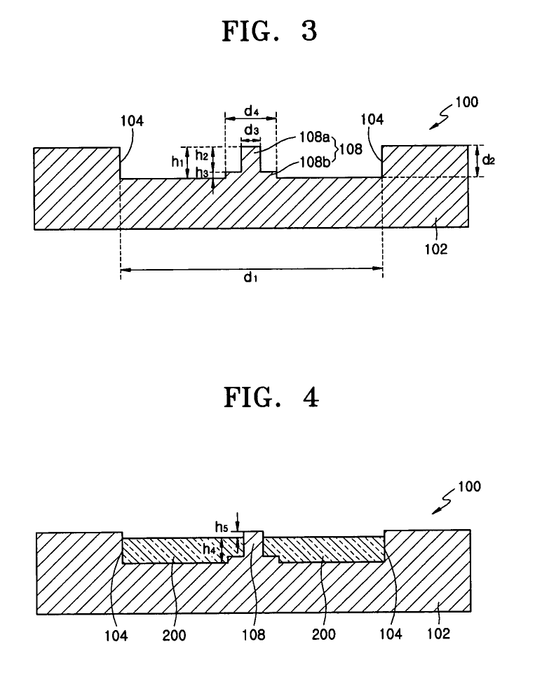

FIG. 2 is a perspective view of a jig used in a method of forming a cover layer of a small form factor optical disk according to another embodiment of the present invention.

In detail, a jig 100 according to the present embodiment is the same as the jig 100 according to the previous embodiment in terms of structure and effect except that walls 104 mounting optical disk plates therein are arranged in a row. The same reference numerals of FIG. 2 as those of FIG. 1 denote like elements.

As shown in FIG. 2, in the jig 100 according to the present embodiment, optical disk plates are mounted in horizontal and vertical directions in the walls 104 having cylindrical shapes. The walls 104 are formed in a row so as to form cover layers of small form factor optical disks on a massive scale.

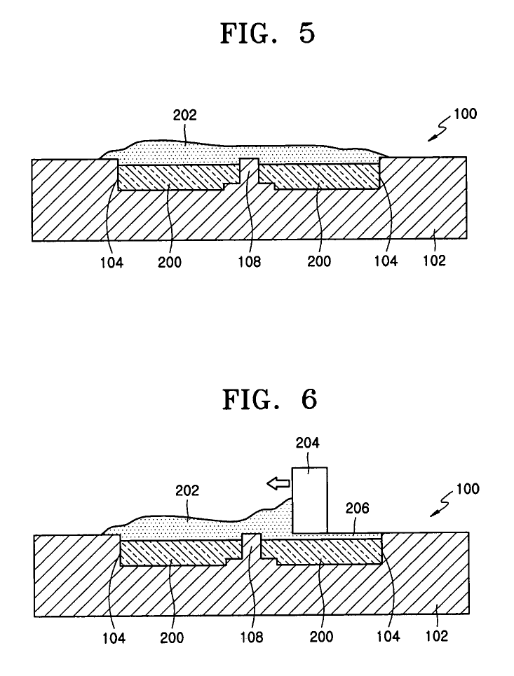

FIG. 3 is a cross-sectional view of a jig used in a method of forming a cover layer of a small form factor optical disk according to an embodiment of the present invention.

In detail, for convenience, a wall of a jig as shown in FIG. 1 or 2 is shown in FIG. 3. As previously described, a jig 100 includes a body 102 and a wall 104 that is formed inside the body 102 and cylindrical, has an exposed surface, a predetermined depth, and a predetermined diameter, and mounts an optical disk plate (not shown) therein. The optical disk plate is mounted inside the wall 104 during forming of a cover layer. The optical disk plate has a reflective layer, a phathalocyanine dye data receiving layer, or a metal layer. A diameter d1 of the wall 104 is equal to a small form factor diameter of the optical disk plate, for example, 28 mm. A bottom 106 of the wall 104 is formed to a predetermined depth inside the body 102. A depth d2 of the wall 104 may be slightly larger than a thickness of the optical disk plate.

A pin 108 is positioned in a center of the wall 104. The pin 108 is combined with a central hole of the optical disk plate. A height h1 of the pin 108 is equal to a height (the depth d2) of the wall 104. The pin 108 includes an upper portion 108a having a diameter d3 and a height h2 and a lower portion 108b having a diameter d4 and a height h3.

In particular, the diameter d4 of the lower portion 108b of the pin 108 is larger than the diameter d3 of the upper portion 108a of the pin 108, and the height h3 of the lower portion 108b is lower than the height h2 of the upper portion 108a. The structure of the pin 108 is inserted into a metal hub constituting an optical disk. As will be described later, a recessed portion is formed in a surface of the optical disk plate put in the pin 108, and the metal hub is mounted in the recessed portion and the central hole. After the optical disk plate is mounted inside the wall 104, a cover layer is formed.

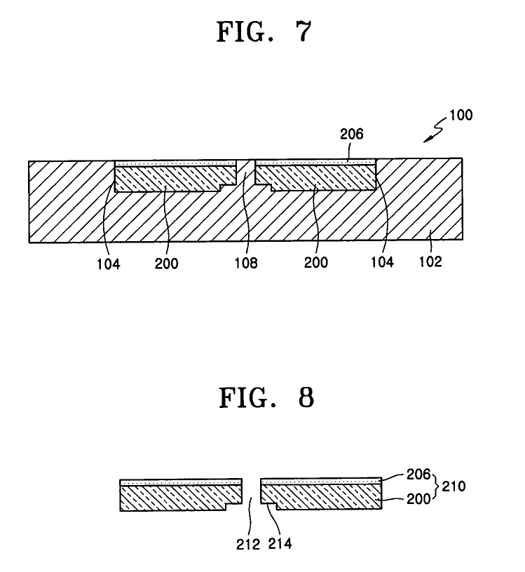

FIGS. 4 through 8 are cross-sectional views illustrating a method of forming a cover layer of a small form factor optical disk using a jig according to an embodiment of the present invention.

The same reference numerals of FIGS. 4 through 8 as those of FIGS. 1 through 3 denote like elements. Also, for convenience, a cover layer is formed in one optical disk. Thus, FIG. 4 shows a wall 104 of the jig 100 shown in FIG. 1, 2, or 3.

Referring to FIG. 4, a jig 100 is prepared to form a cover layer of a small form factor optical disk as shown in FIGS. 1 through 3. A small form factor optical disk plate 200 is inserted into and adhered to the jig 100. The small form factor optical disk plate 200 is adhered to the jig 100 using a vacuum adsorbing method.

As previously described, the small form factor optical disk plate 200 includes a reflective layer, a dye data receiving layer, or a metal layer. As previously described, the jig 100 includes a body 102, the wall 104 that is formed inside the body 102 and cylindrical, has an exposed surface, a predetermined depth, and a predetermined diameter, and mounts the small form factor optical disk plate 200 therein, and a pin 108 positioned in a center of the wall 104.

Thus, when a central hole of the small form factor optical disk plate 200 is put on the pin 108, the small form factor optical disk plate 200 is inserted into and mounted in the wall 104. Since a height h1 of the pin 108 is slightly thicker than a thickness h4 of the small form factor optical disk plate 200, the pin 108 protrudes more than a surface of the small form factor optical disk plate 200 by a height h5. A difference between a height of the pin 108 and a thickness of the small for factor optical disk plate 200, i.e., the height h5, will be a thickness of the cover layer. The thickness h4 is about 0.6 mm, and the height h5 is within a range of about 0.1 mm.

Referring to FIG. 5, an optical hardening material layer 202 is coated on the small form factor optical disk plate 200 inserted into the wall 104 of the jig 100 using a screen printing method. Since the optical hardening material layer 202 is coated using the screen printing method, the optical hardening material layer 202 is very thickly and non-uniformly formed on the surface of the small form factor optical disk plate 200. The optical hardening material layer 202 is generally formed of a lacquer.

The optical hardening material layer 202 will be planarized and become a cover layer of a small form factor optical disk later. In other words, the optical hardening material layer 202 increases a recording density of the small form factor optical disk and protects the small form factor optical disk from external foreign materials or external impacts.

Referring to FIG. 6, the optical hardening material layer 202 coated on the small form factor optical disk plate 200 is planarized using a planarizer 204 to form a cover layer 206. The planarizer 204 planarizes the optical hardening material layer 202 coated on the small form factor optical disk plate 200 so that a surface of the optical hardening material layer 202 is equal to a surface of the jig 100 and removes unnecessary portions of the optical hardening material layer 200. In other words, the planarizer 204 regularly moves from the right side of the surface of the jig 100 toward the left side of the surface of the jig 100 to remove the unnecessary portions of the optical hardening material layer 202. When the optical hardening material layer 202 is planarized, the cover layer 206 having a uniform height is formed on the surface of the small form factor optical disk plate 200.

Referring to FIG. 7, the cover layer 206 coated on the small form factor optical disk plate 200 is hardened. The cover layer 206 is hardened at a temperature between 150° C. and 200° C. Thus, the cover layer 206 is uniformly formed on the small form factor optical disk plate 200 mounted inside the wall 104 of the jig 100. As previously described, the surface of the cover layer 206 is equal to the surface of the wall 104 of the jig 100.

Referring to FIG. 8, the small form factor optical disk plate 200 on which the cover layer 206 has been formed is separated from the jig 100. As a result, an optical disk 210 including the small form factor optical disk plate 200 and the cover layer 206 formed on the small form factor optical disk plate 200 is completed. A metal hub (not shown) is mounted in or attached to a central hole 212 and a recessed part 214 of the optical disk 210. The optical disk 210 smoothly rotates in an information storage device due to the metal hub so as to record or read information.

As described above, the present invention provides a jig used in forming a cover layer of a small form factor optical disk. The jig includes a body, cylindrical walls in which optical disk plates are mounted to a predetermined depth inside the body, and pins positioned in centers of the cylindrical walls and combined with central holes of the optical disk plates.

In the present invention, a cover layer of a small form factor optical disk is formed using the jig. In other words, the jig can be used to simply and uniformly form the cover layer without processes of adhering an adhesive film and a polymer film. Since the two processes do not need to be performed in clean conditions, fabricating cost for an optical disk can be greatly reduced.

Since the jig is used to form the cover layer of the small form factor, the cover layer can be uniformly and flatly formed using a very simple process.

Also, in a case where walls of the jig are arranged in a row to form cover layers of small form factor optical disk, cover layers of small form factor optical disks can be formed within a short time on a massive scale.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A jig used in forming a cover layer of a small form factor optical disk, comprising:
a body;
a cylindrical wall formed inside the body and mounting an optical disk plate to a predetermined depth; and
a pin positioned in a center of the cylindrical wall and combined with a central hole of the optical disk plate.

2. The jig of claim 1, wherein a diameter of the cylindrical wall is equal to a diameter of the optical disk plate.

3. The jig of claim 1, wherein an upper surface of the cylindrical wall is formed of an upper surface of the body.

4. The jig of claim 1, wherein a depth of the cylindrical wall is larger than a thickness of an optical disk plate.

5. The jig of claim 1, wherein a height of the pin is equal to a height of the cylindrical wall.

6. The jig of claim 1, wherein a plurality of walls are formed inside the body.

7. The jig of claim 1, wherein a plurality of walls are arranged in a row in horizontal and vertical directions inside the body.

8. A method of forming a cover layer of a small form factor optical disk, comprising:
mounting a small form factor optical disk plate in a jig comprising a body, a cylindrical wall formed to a predetermined depth inside the body, and a pin positioned in a center of the cylindrical wall;
coating an optical hardening material layer on an optical disk plate mounted in the jig;
planarizing the optical hardening material layer;
hardening the optical hardening material layer to form a cover layer on the optical disk plate; and
separating the optical disk plate on which the cover layer has been formed from the jig.

9. The method of claim 8, wherein the optical hardening material layer is coated using a screen printing method.

10. The method of claim 9, wherein the optical hardening material layer is formed of a transparent lacquer.

11. The method of claim 8, wherein the optical hardening material layer is planarized by a planarizer.

12. The method of claim 8, wherein the cover layer is formed to a thickness corresponding to a difference between a height of the pin of the jig and a thickness of the optical disk plate.
